(19) United States
(12) Patent Application Publication
(10) Pub. No.: US 2025/0326458 A1
(43) Pub. Date: Oct. 23, 2025

(54) FRONT FORKS FOR BICYCLES

(71) Applicant: SRAM, LLC, CHICAGO, IL (US)

(72) Inventors: BRONSON STAGNER, COLORADO SPRINGS, CO (US); DAVID CAMP, LITTLETON, CO (US)

(73) Assignee: SRAM, LLC, CHICAGO, IL (US)

(21) Appl. No.: 18/640,079

(22) Filed: Apr. 19, 2024

(51) Int. Cl. B62K 25/08; F16F 9/02; F16F 9/516

(52) U.S. Cl. CPC B62K 25/08; F16F 9/0281; F16F 9/516

(57) ABSTRACT

Front forks for bicycles are described herein. An example front fork includes a leg including an upper tube and a lower tube configured in a telescopic arrangement and an air spring in the leg. The air spring includes a pneumatic chamber and a piston in the pneumatic chamber. The piston divides the pneumatic chamber into a positive air chamber and a negative air chamber. The front fork also includes a rebound damper including a rebound damper chamber. The rebound damper chamber is in fluid communication with the positive air chamber through an orifice such that during a rebound event air in the rebound damper chamber flows into the positive air chamber at a metered rate.

### FIELD OF THE DISCLOSURE

This disclosure relates generally to bicycle components and, more specifically, to front forks for bicycles.

### BACKGROUND

Bicycles are known to have suspension components. Suspension components are used for various applications, such as cushioning impacts, vibrations, or other disturbances experienced by the bicycle and rider during use as well as maintaining ground contact for traction. A common application for suspension components on bicycles is cushioning impacts or vibrations experienced by the rider when the bicycle is ridden over bumps, ruts, rocks, potholes, and/or other obstacles. These suspension components include rear and/or front wheel suspension components. For example, some bicycles include a front fork with telescoping legs that incorporate a spring and/or damper system.

### SUMMARY

An example front fork for a bicycle disclosed herein includes a leg including an upper tube and a lower tube configured in a telescopic arrangement and an air spring in the leg. The air spring includes a pneumatic chamber and a piston in the pneumatic chamber. The piston divides the pneumatic chamber into a positive air chamber and a negative air chamber. The front fork also includes a rebound damper including a rebound damper chamber. The rebound damper chamber is in fluid communication with the positive air chamber via a first flow path and a second flow path. The first flow path is defined by an orifice. During a compression event, the first flow path and the second flow path are configured to allow air to flow from the positive air chamber to the rebound damper chamber. During a rebound event, the second flow path is configured to be closed such that air in the rebound damper chamber flows along the first flow path through the orifice into the positive air chamber at a metered rate.

Another example front fork for a bicycle disclosed herein includes a leg including an upper tube and a lower tube configured in a telescopic arrangement and a piston in an interior of the upper tube. The piston divides the interior of the upper tube into a positive air chamber and a negative air chamber. The front fork includes a cylinder in the upper tube. The cylinder defines a rebound damper chamber. The front fork also includes a flow control member having an orifice. The orifice defines a portion of a flow path between the rebound damper chamber and the positive air chamber. The orifice is to restrict air flow from the rebound damper chamber to the positive air chamber during a high speed rebound event.

### BRIEF DESCRIPTION OF THE DRAWINGS

FIG. 1 is a side view of an example bicycle that can employ any of the example front forks disclosed herein.

FIG. 2 is a perspective view of an example front fork that can be implemented on the example bicycle of FIG. 1.

FIG. 3 is a cross-sectional view of the example front fork of FIG. 2 showing an example damper incorporated into a first leg of the example front fork and an example air spring incorporated into a second leg of the example front fork.

FIG. 4 is an enlarged view of the callout of FIG. 3 showing a top portion of the second leg including an example air spring rebound damper.

FIG. 5 is a perspective cross-sectional view of the example air spring rebound damper of FIG. 4.

FIG. 6 is a cross-sectional view of the second leg of the example front fork of FIG. 3 having an alternative example air spring rebound damper.

FIG. 7 is an enlarged view of the callout of FIG. 6 showing a top portion of the second leg including the example air spring rebound damper.

FIG. 8 is a perspective cross-sectional view of the example air spring rebound damper of FIG. 7.

FIG. 9 is a perspective view of an example restrictor adjuster of the example air spring rebound damper of FIGS. 7 and 8.

FIG. 10 is a top view of an example cap and the example air spring rebound damper of FIGS. 7, 8, and 9.

FIG. 11 is a cross-sectional view of the example cap and the example air spring rebound damper taking along line A-A of FIG. 10.

FIG. 12 is a cross-sectional view of the top portion of the second leg with the example air spring rebound damper of FIG. 4 and including an example travel spacer.

FIG. 13 is a graph of force versus displacement of a positive air chamber without an example air spring rebound damper during a high speed compression and rebound cycle.

FIG. 14 is a graph of force versus displacement o fa positive air chamber with an example air spring rebound damper during the same high speed compression and rebound cycle.

The figures are not to scale. Instead, the thickness of the layers or regions may be enlarged in the drawings. In general, the same reference numbers will be used throughout the drawing(s) and accompanying written description to refer to the same or like parts.

Descriptors “first,” “second,” “third,” etc. are used herein when identifying multiple elements or components that may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Bicycles are known to have one or more suspension components. Some front forks are configured as suspension components. A front suspension fork typically includes a crown, a steerer tube extending upward from the crown and connected to the handlebars, and two legs extending downward from the crown that are connected to the front wheel. Each leg has an upper cylindrical tube that is coupled to the crown and a lower cylindrical tube that is to be connected to the front wheel. The upper and lower cylindrical tubes are arranged in a telescopic relationship. The front fork may have a damper and a spring, such as an air spring, that act in conjunction to absorb shocks, impulses, and vibrations. The spring is configured to resist compression of the upper and lower tubes and return or expand the fork back to the original riding setup, whereas the damper is configured to dampen the compression and expansion movements of the front fork. The damper is incorporated into one of the legs and the air spring is incorporated into the other leg. While metal coil springs provide a relatively linear spring rate throughout their entire stroke, many modern front forks utilize air springs because of the ability to uniquely adjust the air spring rate throughout the stroke and also independently adjust the spring rate in the compression direction and the rebound direction.

An air spring for a front fork includes a pneumatic chamber with a piston that divides the pneumatic chamber into a positive air chamber and a negative air chamber. In some examples, the pneumatic chamber is disposed in and coupled to the upper tube. The air spring includes a shaft coupled to the lower tube that extends into the pneumatic chamber and is coupled to the piston. When the front fork compresses, such as when riding over a bump, the piston is forced upward in the pneumatic chamber, which increases the pressure in the positive air chamber and decreases the pressure in the negative air chamber. After the compressive force is removed, the increased pressure in the positive air chamber and the decreased pressure in the negative air chamber acts to move the piston downward, which cause the front fork to expand back to the original riding setup.

Air springs have a non-linear spring rate is that impacted by speed, temperature, and displacement. For example, a low speed compression of an air spring produces lower forces and is therefore followed by a low speed rebound, whereas a high speed compression of the air spring produces higher forces and is therefore followed by a high speed rebound. The end of the spring curve (force versus displacement) at high speeds can produce significant spring forces. The rider experiences this end of stroke force as additional support at speed during compression, which is beneficial. However, during rebound, the damper in the front fork is left to deal with significant spring forces extending the fork rapidly. This high spring force during rebound can make the front fork feel overactive and chaotic with traditional damper settings. While the rider can increase their damper settings in the front fork in attempts to accommodate this circumstance, this often leads to an overly damped setting for a significant amount of terrain.

Disclosed herein is an example front fork with an air spring that includes an air spring rebound damper. The air spring rebound damper includes or defines a rebound damper chamber that is in fluid communication with the positive air chamber. The air spring rebound damper includes an orifice that defines a first flow path between the rebound damper chamber and the positive air chamber. The air spring also includes a second flow path defined by a one-way valve (e.g., a check valve). During a compression event, as the pressure in the positive air chamber increases, a portion of the air from the positive air chamber flows through the orifice and into the rebound damper chamber. Further, during the compression event, the one-way valve is opened, which allows additional (increased) air flow along the second flow path from the positive air chamber into the rebound damper chamber. During the following rebound event, the one-way valve is configured to close and therefore block air flow through the second flow path. The air in the rebound damper chamber can flow through the orifice and back into the positive air chamber, but is metered and therefore flows at a reduced or slower rate back to the positive air chamber. As such, the force produced by the positive air chamber is lessened. This reduces the rebound spring force so that the front fork feels less overactive or chaotic. Therefore, the rider does not need to adjust their damper settings to accommodate the high speed rebound action. In some examples disclosed herein, the air spring rebound damper includes a restrictor adjuster (e.g., a damper adjustor dial or pin) with multiple orifices that are different sizes and, which can be selected based on the desired amount of air damping. A user can adjust (e.g., rotate) the restrictor adjuster to select their desired amount of air damping.

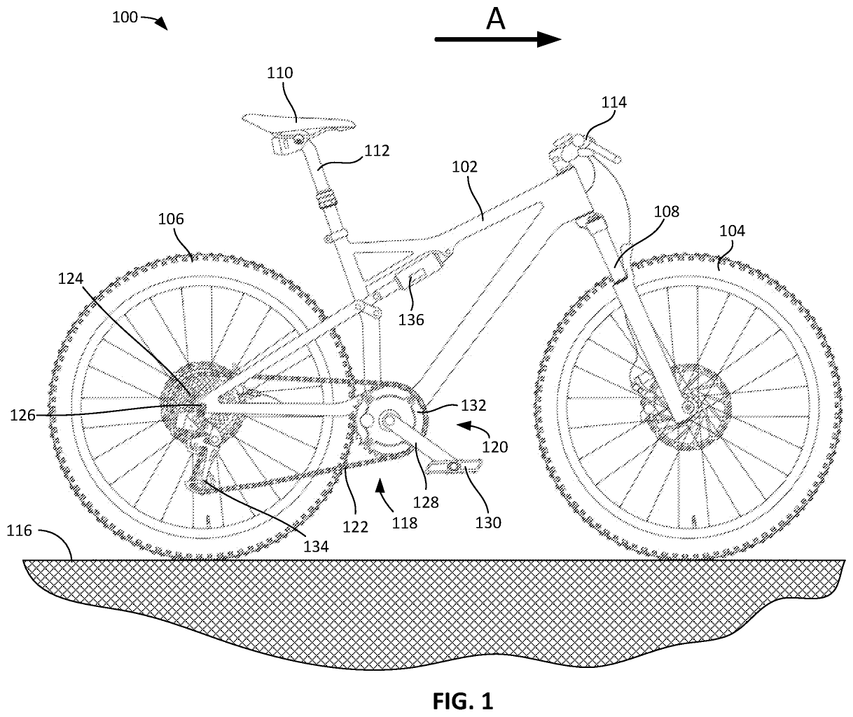

Turning now to the figures, FIG. 1 illustrates one example of a human powered vehicle on which the example front forks disclosed herein may be implemented. In this example, the vehicle is one possible type of bicycle 100, such as a mountain bicycle. In the illustrated example, the bicycle 100 includes a frame 102 and a front wheel 104 and a rear wheel 106 rotatably coupled to the frame 102. In the illustrated example, the front wheel 104 is coupled to the front end of the frame 102 via a front fork 108. A front and/or forward riding direction or orientation of the bicycle 100 is indicated by the direction of the arrow A in FIG. 1. As such, a forward direction of movement for the bicycle 100 is indicated by the direction of arrow A.

In the illustrated example of FIG. 1, the bicycle 100 includes a seat 110 coupled to the frame 102 (e.g., near the rear end of the frame 102 relative to the forward direction A) via a seat post 112. The bicycle 100 also includes handlebars 114 coupled to the front fork 108 (e.g., near a forward end of the frame 102 relative to the forward direction A) for steering the bicycle 100. The bicycle 100 is shown on a riding surface 116. The riding surface 116 may be any riding surface such as the ground (e.g., a dirt path, a sidewalk, a street, etc.), a man-made structure above the ground (e.g., a wooden ramp), and/or any other surface.

In the illustrated example, the bicycle 100 has a drivetrain 118 that includes a crank assembly 120. The crank assembly 120 is operatively coupled via a chain 122 to a sprocket assembly 124 mounted to a hub 126 of the rear wheel 106. The crank assembly 120 includes at least one, and typically two, crank arms 128 and pedals 130, along with at least one front sprocket, or chainring 132. A rear gear change device 134, such as a derailleur, is disposed at the rear wheel 106 to move the chain 122 through different sprockets of the sprocket assembly 124. Additionally or alternatively, the bicycle 100 may include a front gear change device to move the chain 122 through gears on the chainring 132.

The example bicycle 100 includes a suspension system having one or more suspension components. In this example, the front fork 108 is implemented as a front suspension component. The front fork 108 is or integrates a shock absorber that includes a spring and a damper, disclosed in further detail herein. Further, in the illustrated example, the bicycle 100 includes a rear suspension component 136, which is a shock absorber, referred to herein as the rear shock absorber 136. The rear shock absorber 136 is coupled between two portions of the frame 102. The front fork 108 and the rear shock absorber 136 absorb shocks and vibrations while riding the bicycle 100 (e.g., when riding over rough terrain). In other examples, the front fork 108 and/or the rear shock absorber 136 may be integrated into the bicycle 100 in other configurations or arrangements. Further, in other examples, the suspension system may employ only one suspension component (e.g., only the front fork 108) or more than two suspension components (e.g., an additional suspension component on the seat post 112) in addition to or as an alternative to the front fork 108 and rear shock absorber 136.

While the example bicycle 100 depicted in FIG. 1 is a type of mountain bicycle, the example front forks and air springs disclosed herein can be implemented on other types of bicycles. For example, the disclosed front forks and air springs may be used on road bicycles, as well as bicycles with mechanical (e.g., cable, hydraulic, pneumatic, etc.) and non-mechanical (e.g., wired, wireless) drive systems. The disclosed front forks and air springs can also be implemented on other types of two-wheeled, three-wheeled, and four-wheeled human powered vehicles. Further, the example front forks and air springs can be used on other types of vehicles, such as motorized vehicles (e.g., a motorcycle, a car, a truck, etc.).

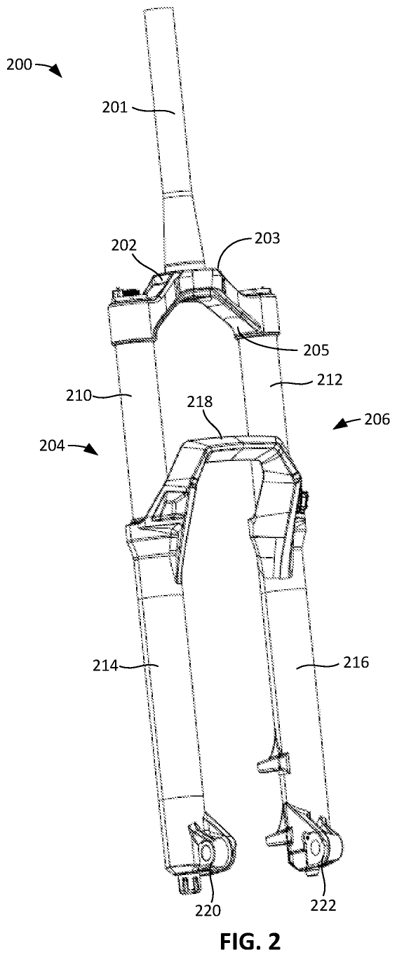

FIG. 2 is a perspective view of an example front fork 200 (a suspension component) that can be implemented as the front fork 108 on the bicycle 100 of FIG. 1. In the illustrated example of FIG. 2, the front fork 200 includes a steerer tube 201, a crown 202, a first leg 204, and a second leg 206. The crown 202 has a top side 203 and a bottom side 205 opposite the top side 203. The steerer tube 201 is coupled to the crown 202 and extends outward (e.g., upward) from the top side 203 of the crown 202. The steerer tube 201 is to be inserted through a head tube on the frame 102 (FIG. 1) of the bicycle 100 and coupled to the handlebars 114 (FIG. 1) (e.g., via a stem). The first and second legs 204, 206 are coupled to the crown 202 and extend outward (e.g., downward) from the bottom side 205 of the crown 202, opposite the steerer tube 201. The first and second legs 204, 206 are to be coupled to the front wheel 104 (FIG. 1).

In the illustrated example, the first leg 204 includes a first tube 210 and a second tube 214, referred to herein as a first upper tube 210 and a first lower tube 214, respectively, because of the orientation or configuration when installed on a bicycle. The second leg 206 similarly includes a first tube 212 and a second tube 216, referred to herein as a second upper tube 212 and a second lower tube 216, respectively. The upper and lower tubes 210, 212, 214, 216 are sometimes referred to as stanchions or leg portions. The first and second upper tubes 210, 212 are coupled to and extend downward from the crown 202. The front fork 200 includes an arch 218 (sometimes referred to as a fork brace or stabilizer) coupled between the lower tubes 214, 216. In some instances, the upper tubes 210, 212 are referred to as an upper tube assembly, while the lower tubes 214, 216 and the arch 218 are referred to as a lower tube assembly. The first and second lower tubes 214, 216 include respective front wheel attachment portions 220, 222, such as holes (e.g., eyelets) or dropouts, for attaching the front wheel 104 (FIG. 1) to the front fork 200.

The first and second upper tubes 210, 212 are slidably received within the respective first and second lower tubes 214, 216. Thus, the first and second upper tubes 210, 212 form a telescopic arrangement with the respective first and second lower tubes 214, 216. During a compression stroke, the first and second upper tubes 210, 212 move into or toward the respective first and second lower tubes 214, 216, and during a rebound stroke, the first and second upper tubes 210, 212 move out of or away from the respective first and second lower tubes 214, 216.

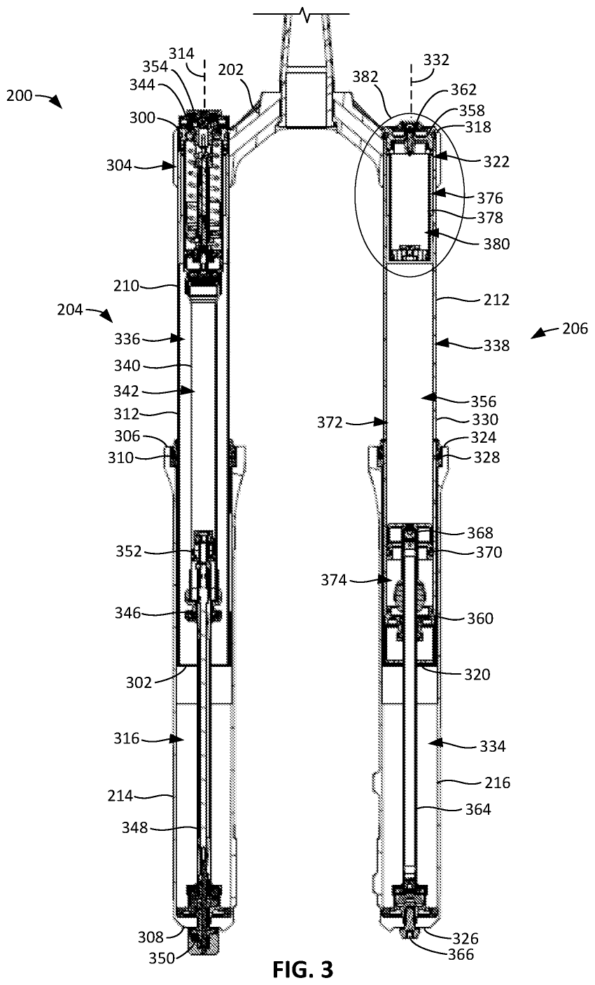

FIG. 3 is a cross-sectional view of the example front fork 200. As shown in FIG. 3, the first upper tube 210 has a first end 300, referred to herein as a top end 300, and a second end 302, referred to herein as a bottom end 302, opposite the top end 300. The top end 300 is coupled to the crown 202. In the illustrated example, a portion of the first upper tube 210 extends into an opening 304 in the crown 202. In some examples, the first upper tube 210 is friction fit in the opening 304. Additionally or alternatively, the first upper tube 210 can be coupled to the crown 202 via another mechanical and/or chemical fastening technique (e.g., threaded fasteners, welding, an adhesive, etc.). The first lower tube 214 has a first end 306, referred to herein as a top end 306, and a second end 308, referred to herein as a bottom end 308, opposite the top end 306. The first upper tube 210 is inserted into the first lower tube 214. In particular, the bottom end 302 of the first upper tube 210 is disposed within the first lower tube 214. This type of configuration is sometimes referred to as a right side up fork. The front fork 200 includes a wiper seal 310 that is coupled to the first lower tube 214 near the top end 306. The wiper seal 310 slides along an outer surface 312 of the first upper tube 210 as the front fork 200 compresses or rebounds. The top end 300 of the first upper tube 210 and the bottom end 308 of the first lower tube 214 form first and second distal ends of the suspension component. During compression, the top end 300 and the bottom end 308 are moved toward each other, and during extension or rebound, the top end 300 and the bottom end 306 are moved away from each other. Thus, the first upper and lower tubes 210, 214 form a telescopic arrangement and move along a central axis 314 of the first leg 204. The first upper and lower tubes 210, 214 define an interior chamber or region 316.

The second upper and lower tubes 212, 216 are similarly arranged. In particular, the second upper tube 210 has a first end 318, referred to herein as a top end 318, and a second end 320, referred to herein as a bottom end 320, opposite the top end 318. The top end 318 is coupled to the crown 202. In the illustrated example, a portion of the second upper tube 212 extends into an opening 322 in the crown 202. In some examples, the second upper tube 212 is friction fit in the opening 322. Additionally or alternatively, the second upper tube 212 can be coupled to the crown 202 via another mechanical and/or chemical fastening technique (e.g., threaded fasteners, welding, an adhesive, etc.). The second lower tube 216 has a first end 324, referred to herein as a top end 324, and a second end 326, referred to herein as a bottom end 326, opposite the top end 324. The second upper tube 212 is inserted into the second lower tube 216. In particular, the bottom end 320 of the second upper tube 212 is disposed within the second lower tube 216. The front fork 200 includes a wiper seal 328 that is coupled to the second lower tube 216 near the top end 324. The wiper seal 328 slides along an outer surface 330 of the second upper tube 212 as the front fork 200 compresses or rebounds. The second upper and lower tubes 212, 216 form a telescopic arrangement and move along a central axis 332 of the second leg 206. The second upper and lower tubes 212, 216 define an interior chamber or region 334.

In the illustrated example, the front fork 200 includes both a damper 336 and a spring 338. The damper 336 is disposed in and/or otherwise incorporated into the first leg 204, and the spring 338 is disposed in and/or otherwise incorporated into the second leg 206. In this example, the spring 338 is implemented as an air spring, referred to herein as the air spring 338. The air spring 338 is configured to resist compression of the top ends 300, 318 toward the bottom ends 308, 326 and return the tubes 210, 212, 214, 216 to the extended position after compression occurs. The damper 336 is configured to limit the speed at which the compression/extension occurs and/or otherwise absorb vibrations.

In the illustrated example, the damper 336 includes a damper body 340 that defines a chamber 342 (e.g., a hydraulic chamber). The damper body 340 is disposed in and coupled to the first upper tube 210. In particular, the front fork 200 includes a first cap 344 coupled (e.g., threadably coupled) to the top end 300 of the first upper tube 210. The damper body 340 is coupled to and extends downward from the first cap 344. As such, the damper body 340 is coupled to and disposed in a fixed position in the first upper tube 210. The bottom of the chamber 342 is sealed by a sealhead 346. The chamber 342 is filled with fluid. The fluid may be, for example, oil, such as a mineral oil based damping fluid. In other examples, other types of damping fluids may be used (e.g., silicone or glycol type fluids). The damper 336 includes a first shaft 348 (which may be referred to as a damper or piston shaft, rod, or stem). The first shaft 348 is coupled to the bottom end 308 of the first lower tube 214 by a threaded fastener 350. The first shaft 348 extends upward and through the sealhead 346 on the damper body 340 and into the chamber 342. The damper 336 includes a damper member 352 (which may also be referred to as a piston or mid-valve) disposed in the chamber 342 of the damper body 340. The damper member 352 is coupled to the first shaft 348 and is slidable in the damper body 340. The damper member 352 divides the chamber 342 into two chambers (above and below the damper member 352). When the front fork 200 compresses and the ends of the first upper and lower tubes 210, 214 move toward each other, such as when riding over a bump, the first shaft 348 moves the damper member 352 upward in the chamber 342 toward the top end 300 of the first upper tube 210. During rebound, the damper member 352 moves downward in the chamber 342 away from the top end 300 of the first upper tube 210. The damper member 352 includes one or more channels that enable fluid to flow across the damper member 352, at a restricted rate, between the first and second chambers, thereby damping or slowing the compression/extension movement of the front fork 200. In the illustrated example, the damper 336 includes an adjustment knob 354 on the first cap 344 that can be used to adjust the damping rate of the damper 336. In some examples, the adjustment knob 354 includes two adjustors, one for high-speed compression damping and one for low-speed compression damping. The adjustment knob 354 can be accessed by a user or rider and adjusted (e.g., pushed, rotated, etc.) to affect the damping rate provided by the damper 336.

In the illustrated example, the air spring 338 includes a pneumatic chamber 356. In this example, the pneumatic chamber 356 is defined by an interior of the second upper tube 212. However, in other examples, the pneumatic chamber 356 can be defined by a separate cylinder or body that is disposed in the second upper tube 212, similar to the damper body 340 in the first upper tube 210. In the illustrated example, the front fork 200 includes a second cap 358 that is coupled (e.g., threadably coupled) to the top end 318 of the second upper tube 212 and seals the top of the pneumatic chamber 356. The front fork 200 includes a sealhead 360 coupled to and disposed in the second upper tube 212 near the bottom end 320 that seals the bottom of the pneumatic chamber 356. The second cap 358 includes a valve 362 (e.g., a Schrader valve) that can be used to fill the pneumatic chamber 356 with fluid (e.g., compressed air).

In the illustrated example, the air spring 338 includes a shaft 364 that is coupled to the bottom end 326 of the second lower tube 216 via a threaded fastener 366. The shaft 364 extends upward and through the sealhead 360 and into the pneumatic chamber 356. The air spring 338 includes a piston 368 that is coupled (e.g., threadably coupled) to an end of the shaft 364 and disposed in the pneumatic chamber 356 in the second upper tube 212. The piston 368 is slidable within the second upper tube 212. In some examples, a seal 370 is disposed around the piston 368, which creates a seal between the piston 368 and the inner surface of the second upper tube 212.

The piston 368 divides the pneumatic chamber 356 into a first chamber 372, referred to herein as a positive air chamber 372, and a second chamber 374, referred to herein as a negative air chamber. In some examples, the positive air chamber 372 is filled with a mass of a pneumatic fluid (e.g., a gas, such as air) having a higher pressure than ambient pressure. Therefore, in this example, the positive air chamber 372 forms a pressurized chamber, sometimes referred to as a highly pressurized zone or positive spring chamber, above the piston 368. The negative air chamber 374 forms a negative spring chamber below the piston 368. When the front fork 200 compresses and the ends of the second upper and lower tubes 212, 216 move toward each other, such as when riding over a bump, the second shaft 364 moves the piston 368 toward the top end 318 of the second upper tube 212. As a result, the volume of the positive air chamber 372 decreases and, thus, the pressure of the air within the positive air chamber 372 increases. Conversely, the volume of the negative air chamber 374 increases and therefore the pressure of the air in the negative air chamber 374 decreases. After the compressive force is removed, the increased pressure in the positive air chamber 372 and the decreased pressure in the negative air chamber 374 acts to move the piston 368 away from the top end 318, which pushes the ends of the second upper and lower tubes 212, 216 away from each other, thereby acting as a spring to return the front fork 200 to its original or riding set up. The first upper and lower tubes 210, 214 similarly follow this motion.

The force or return rate of the air spring 338 is based on the speed of compression. In particular, a low speed compression of the air spring 338 produces lower forces that result in a low speed rebound, whereas a high speed compression of the air spring 338 produces high forces that result in a high speed rebound. Therefore, after a high speed compression, a front fork can sometimes feel overactive or too responsive to the user.

In the illustrated example, the air spring 338 of the front fork 200 includes an air spring rebound damper 376 to reduce the rebound rate and/or force of the air spring 338 following a high speed compression. The rebound damper 376 includes a rebound damper chamber 380 defined by a cylinder 378 (e.g., a canister). In this example, the cylinder 378 is disposed in the positive air chamber 372 in the upper portion of the second upper tube 212. As disclosed in further detail herein, the rebound damper chamber 380 is in fluid communication with the positive air chamber 372 through an orifice. During a compression event, some of the air from the positive air chamber 372 flows through the orifice and into the chamber 380 of the rebound damper 376. During a rebound event, the air in the rebound damper chamber 380 can flow back into the positive air chamber 372, but at a metered rate or lower flow rate because of the orifice. In other words, the air is released back into the positive air chamber 372 at a slower rate or lower pressure. This reduces the effective pressure applied to the piston 368 from the positive air chamber 372 and, thus, reduces the rebound spring force applied by the air spring 338 to the front fork 200 during a high speed rebound event.

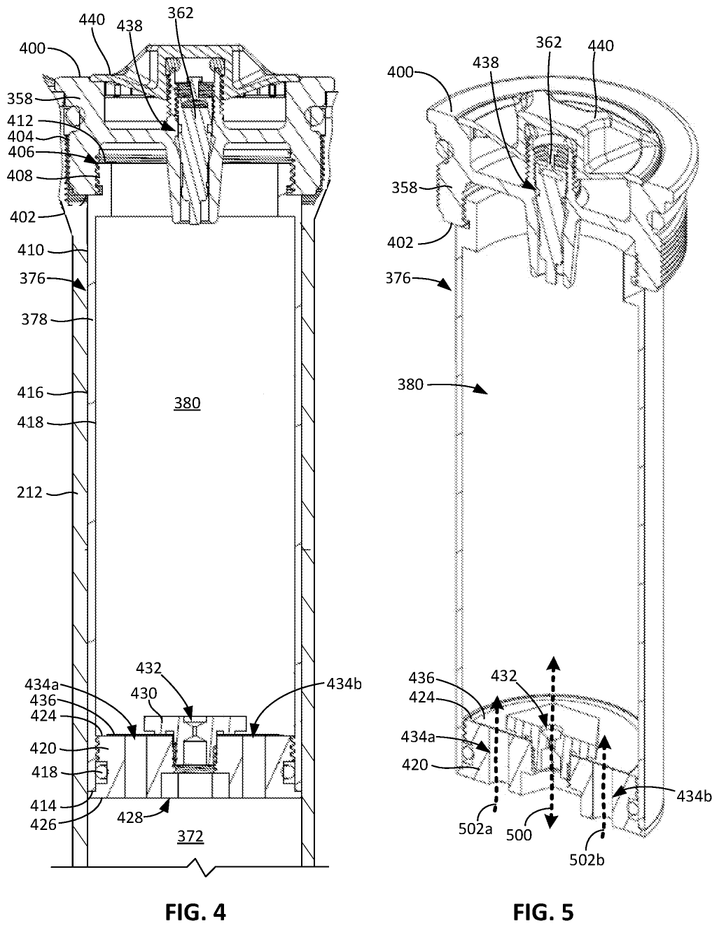

FIG. 4 is an enlarged view of the callout 382 of FIG. 3 showing the rebound damper 376 in the top portion of the second upper tube 212. As disclosed above, the rebound damper 376 includes the cylinder 378 that defines the rebound damper chamber 380. In the illustrated example, the cylinder 378 is coupled to and extends downward from the second cap 358. The second cap 380 has a top side 400, a bottom side 402 opposite the top side 400, an outer side surface 404, and a bore 406 on the bottom side 402 having by an inner surface 408. A portion of the outer side surface 404 is threaded and is screwed into the threads on an inner surface 410 of the second upper tube 212. The cylinder 378 has a first end 412, a second end 414 opposite the first end 412, an outer side surface 416, and an inner surface 418. A portion of the outer side surface 416 of the cylinder 378 near the first end 412 is threaded and is screwed into threads on the inner surface 408 of the second cap 358. As such, the second cap 358 seals the top of the rebound damper chamber 380. Therefore, the second cap 358 may be considered part of the rebound damper 376.

In the illustrated example, the cylinder 378 has an outer diameter that is the same or substantially the same as the inner dimeter of the second upper tube 212. Therefore, the outer surface 416 of the cylinder 378 is engaged with the inner surface of the second upper tube 212 and prevents or limits leakage between the two walls. However, in other examples, the cylinder 378 can have a smaller outer diameter that results in a gap or space between the cylinder 378 and the second upper tube 212.

In the illustrated example, the rebound damper 376 includes a piston 420 (e.g., a damping plate, a plug, a disc) that seals the bottom of the rebound damper chamber 380. The piston 420 is coupled to the cylinder 378 at or near the second end 414. In this example, the piston 420 is partially disposed in the cylinder 378. In this example, the piston 420 is threadably coupled to the cylinder 378, but in other examples can be coupled to the cylinder 378 via other mechanical and/or chemical techniques (e.g., welding, an adhesive, a threaded fastener, etc.). A seal 422 is disposed around the piston 420 to from a fluid tight seal between the piston 420 and the inner surface 418 of the cylinder 378.

In the illustrated example, the piston 420 has a first side 424 and a second side 426 opposite the first side 424. The first side 424 is facing the rebound damper chamber 380 of the rebound damper 376 and the second side 426 is facing the positive air chamber 372. In the illustrated example, the piston 420 has a central passage 428 extending through the piston 420 between the first side 424 and the second side 426. The rebound damper 376 includes a shim nut 430. The shim nut 430 is screwed into the central passage 428 of the piston 420. In this example, the shim nut 430 defines an orifice 432, which enables air flow between the rebound damper chamber 380 and the positive air chamber 372. Therefore, in this example, the shim nut 430 can be considered a flow control member. The orifice 432 defines a portion of a flow path between the rebound damper chamber 380 and the positive air chamber 372. However, the orifice 432 is relatively small, which meters or restricts the flow of air between to the two chambers. In the illustrated example, the piston 420 includes compression channels 434a, 434b that extend through the piston 420 between the first side 424 and the second side 426. The compression channels 434a, 434b allow air to flow from the positive air chamber 372 into the rebound damper chamber 380 during a compression event. In this example, the compression channels 434a, 434b are radially offset from the central passage 428. In this example, the piston 420 has two compression channels 434a, 434b, but in other examples may have only one compression channel or may have more than two compression channels. The rebound damper 376 includes a shim 436 (e.g., a disc, a plate) on the first side 424 of the piston 420 and covering the compression channels 434a, 434b on the first side 424 of the piston 420. The shim nut 430 is coupled to the piston 420 to hold (e.g., clamp) the shim 436 against the first side 424 of the piston 420.

FIG. 5 is a perspective cross-sectional view of the air spring rebound damper 376 and the second cap 358. During a compression event, the piston 368 (FIG. 3) travels upward and increases the air pressure in the positive air chamber 372 (FIG. 4). Some of the air from the positive air chamber 372 flows along a first flow path 500 defined through the orifice 432 and into the chamber 380 of the rebound damper 376. Further, during a high speed compression event, the higher pressure in the positive air chamber 372 causes the shim 436 to bend away from the first side 424 of the piston 420. This allows additional air from the positive air chamber 372 to flow along second flow paths 502a, 502b through the compression channels 434a, 434ba and into the rebound damper chamber 380. As the front fork 200 begins to expand or rebound, the shim 436 re-engages and seals against the first side 424 of the piston 420, which closes the compression channels 434a, 434b. During rebound, air in the rebound damper chamber 380 flows along the first flow path 500 through the orifice 432 and back and into the positive air chamber 372. However, the orifice 432 is relatively small and results in a lower or slower release of the air. As such, air flows out of the positive air chamber 372 at a first higher rate during compression and flows back into the positive air chamber 372 at a second lower rate during rebound. This results in a reduced pressure in the positive air chamber 372 during rebound and therefore reduces the spring force during the high speed rebound. As such, the rebound damper 376 reduces or eliminates the overly active feeling that may otherwise occur without the rebound damper 376 during high speed rebound. Low speed compression and rebound may not be significantly affected by the use of the rebound damper 376 because of the slower speeds at which pressure changes in the positive air chamber 372.

The rebound damper chamber 380 is in fluid communication with the positive air chamber 372 via a first flow path, such as the first flow path 500 defined by the orifice 432, and a second flow path, such as one or both or the second flow paths 502a, 502b defined by the compression channels 434a, 434b. During a compression event, the first flow path (the first flow path 500) and the second flow path (the second flow paths 502a, 502b) are configured to allow air to flow from the positive air chamber 372 to the rebound damper chamber 380. During a rebound event, the second flow path (the second flow paths 502a, 502b) are configured to be closed such that air in the rebound damper chamber 380 flows along the first flow path (the first flow path 500) through the orifice 432 into the positive air chamber 372 at a metered rate. The orifice 432 and, thus, the first flow path (the first flow path 500) is always open and allows air flow during both compression and rebound. The second flow path (the second flow paths 500a, 500b) is formed or defined by a one-way valve, which is configured to be open during compression but closed during rebound. This always additional air flow from the positive air chamber 372 to the rebound damper chamber 380 during a compression event, but forces all of air to flow through the orifice 432 during a rebound event to create the reduced spring force effect disclosed above. In this example, the one-way valve is implemented by the compression channels 434a, 434ba and the shim 436. For example, the shim 436 is configured to bend away from the piston 420 during a compression event, but configured to contact or seal against the piston 420 during a rebound event. In other examples, the one-way valve can be implemented by other types of valves, such as a reed valve or a ball check valve.

In the illustrated example of FIGS. 4 and 5, the fill valve 362 (e.g., a Schrader valve) is coupled to and/or otherwise integrated into the second cap 358. In particular, the second cap 358 includes a central passage 438 that extends between the top side 400 and the bottom side 402. The fill valve 362 is disposed in the central passage 438. A user can open the fill valve 362 to fill the chamber 380 and the chambers 372, 374 with pneumatic fluid, such as high pressure air, and/or release pneumatic fluid from the chambers 372, 374, 380. In the illustrated example, a cover 440 is threadably coupled to the second cap 358 and covers the fill valve 362 to help keep out dirt and debris. A user can remove the cover 440 to access the fill valve 362.

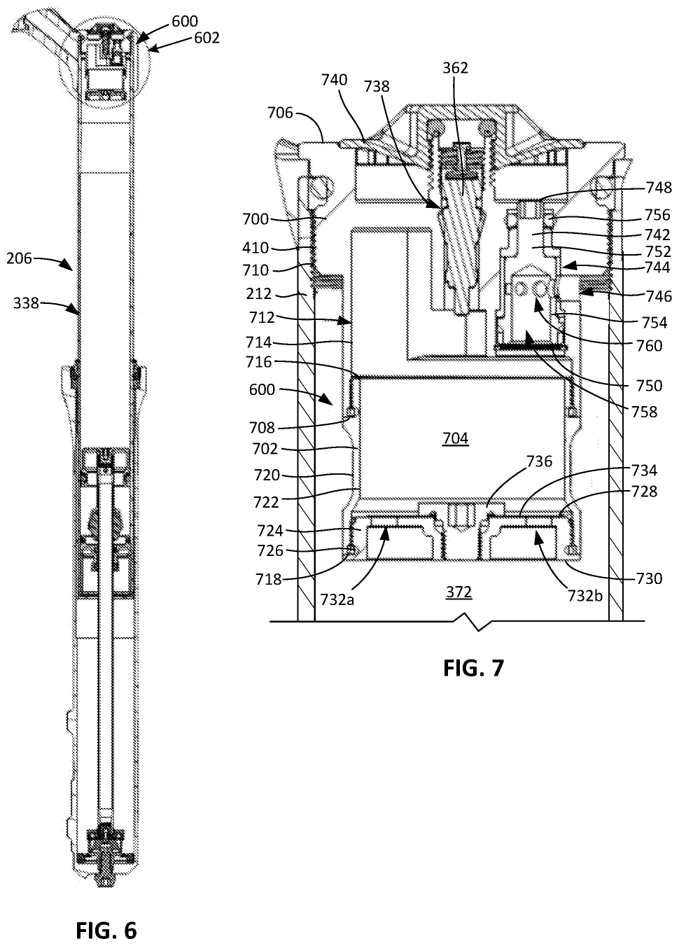

FIG. 6 is a cross-sectional view of the second leg 206 with the air spring 338 and including an alternative rebound damper 600. In this example, the rebound damper 600 has an orifice or hole size that is adjustable to enable a user to adjust the magnitude of the air spring rebound damping.

FIG. 7 is an enlarged view of the callout 602 of FIG. 6 showing the example rebound damper 600 in the top portion of the second upper tube 212. In this example, the second leg 206 includes a second cap 700 that is different than the second cap 358. The rebound damper 600 includes a cylinder 702 that defines a rebound damper chamber 704. The cylinder 702 is coupled to and extends downward from the second cap 700. The second cap 700 has a top side 706, a bottom side 708 opposite the top side 706, an outer side surface 710, and a bore 712 on the bottom side 708 having an inner surface 714. A portion of the outer side surface 710 is threaded and is screwed into the threads on the inner surface 410 of the second upper tube 212. The cylinder 702 of the rebound damper 600 has a first end 716, a second end 718 opposite the first end 716, an outer side surface 720, and an inner surface 722. A portion of the outer side surface 720 of the cylinder 702 near the first end 716 is threaded and is screwed into threads on the inner surface 714 of the second cap 700. As such, the second cap 358 seals the top of the rebound damper chamber 704. In this example, the cylinder 702 has an outer diameter that is less than the inner dimeter of the second upper tube 212. This results in a gap or space between the cylinder 702 and the second upper tube 212 that forms part of the positive air chamber 372.

In the illustrated example, the rebound damper 600 includes a piston 724 (e.g., a damping plate, a plug, a disc) that seals the bottom of the rebound damper chamber 704. The piston 724 is coupled to the cylinder 702 at or near the second end 718. In this example, the piston 724 is partially disposed in the cylinder 702. In this example, the piston 724 is threadably coupled to the cylinder 702, but in other examples can be coupled to the cylinder 702 via other mechanical and/or chemical techniques (e.g., welding, an adhesive, a threaded fastener, etc.). A seal 726 is disposed around the piston 724 to from a fluid tight seal between the piston 724 and the inner surface 722 of the cylinder 702.

The piston 724 has a first side 728 and a second side 730 opposite the first side 728. The first side 728 faces the rebound damper chamber 704 of the rebound damper 600 and the second side 730 faces the positive air chamber 372. The piston 724 includes compression channels 732a, 732b that extend through the piston 420 between the first side 728 and the second side 730. The rebound damper 600 includes a shim 734 (e.g., a disc, a plate) on the first side 728 of the piston 724 that covers the compression channels 732a, 732b. The shim 734 is held (e.g., clamped) onto the first side 728 by a shim nut 736 that is screwed into the piston 724. In this example, the shim nut 736 does not include an orifice as in the example shown in FIG. 4.

In the illustrated example, the fill valve 362 is coupled to and/or otherwise integrated into the second cap 700. In particular, the second cap 358 includes a central passage 738 that extends between the top side 706 and the bottom side 708. The fill valve 362 is disposed in the central passage 738. A user can open the fill valve 362 to fill the rebound damper chamber 704 and the chambers 372, 374 with pneumatic fluid. In the illustrated example, a cover 740 is threadably coupled to the second cap 700 and covers the fill valve 362 to help keep out dirt and debris. A user can remove the cover 740 to access the fill valve 362.

In the illustrated example, the rebound damper 600 includes a restrictor adjuster 742, which is a flow control member that can be used to adjust or control the rebound damping rate provided by the rebound damper 600. The restrictor adjuster 742 can also be referred to as an air spring damper adjustment dial or pin. In the illustrated example, the second cap 700 has an axial opening 744 extending between the top side 706 and the bottom side 708 of the second cap 700. The second cap 700 has a radial opening 746 between the axial opening 744 and the outer side surface 710. The restrictor adjuster 742 is disposed in the axial opening 744 and controls the flow of fluid between the bore 712, which forms part of the rebound damper chamber 704, and the radial opening 746, which forms part of the positive air chamber 372. The restrictor adjuster 742 has a top end 748 and a bottom end 750 opposite the top end 748. The restrictor adjuster 748 has a shaft portion 752 and a sleeve portion 754. In the illustrated example, a seal 756 (e.g., an o-ring) is disposed between the shaft portion 752 and the inner surface of the axial opening 744 to prevent fluid leakage therebetween. The sleeve portion 754 has a hollow interior defined by a bore 758 extending into the bottom end 750. As such, the bore 758 is exposed to and/or filled with the air in the rebound damper chamber 704. In the illustrated example, the sleeve portion 754 has a set of orifices 760 (one of which is referenced in FIG. 7) extending in a radial direction between the bore 758 and an outer surface of the sleeve portion 754. The orifices 760 are different sizes (e.g., diameters). One of the orifices 760 is aligned with the radial opening 746 in the second cap 700, which thereby forms a flow path between the rebound damper chamber 704 and the positive air chamber 372. The restrictor adjuster 742 is rotatable in the axial opening 744. A user can rotate the restrictor adjuster 742 to align different ones of the orifices 760 with the radial opening 746 to adjust the amount of air damping provided by the rebound damper 600. For instance, a larger diameter orifice provides less restriction and, thus, allows more air flow (i.e., less damping), which results in a higher spring force during high speed rebound, whereas a smaller diameter orifice provides more restriction and, thus, allows less air flow (i.e., more damping), which results in a lower spring force during high speed rebound.

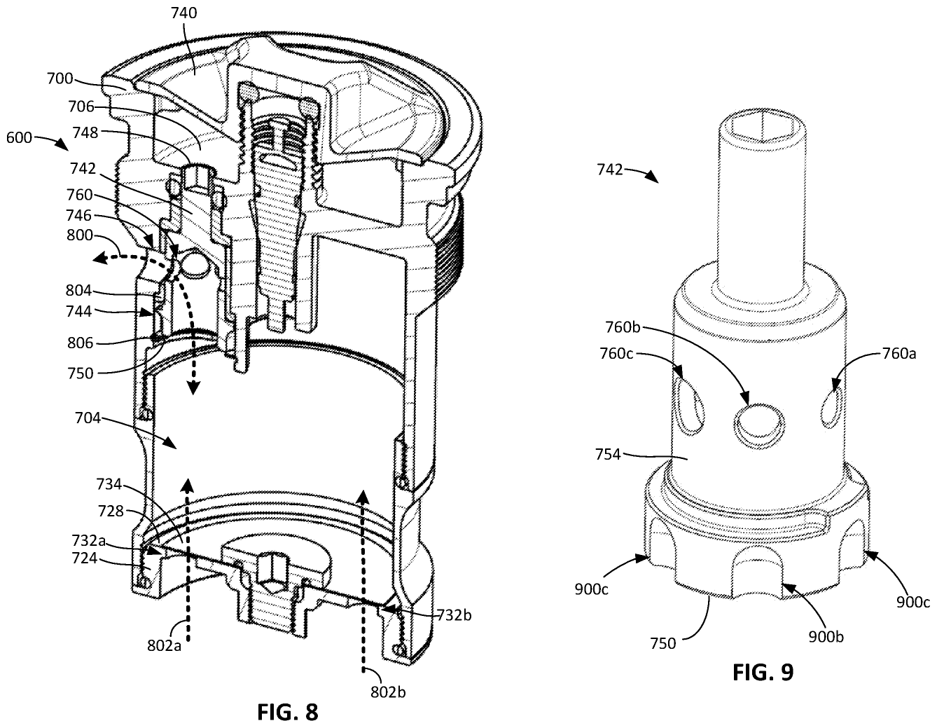

FIG. 8 is a perspective cross-sectional view of the air spring rebound damper 600 and the second cap 700. During a compression event, the piston 368 (FIG. 3) travels upward and increases the air pressure in the positive air chamber 372 (FIG. 7). A portion of the air from the positive air chamber 372 flows along a first flow path 800 through the radial opening 746 in the second cap 700, through the one of the orifices 760 of the restrictor adjuster 742 that is aligned with the radial opening 746, and into the rebound damper chamber 704. Further, during a high speed compression event, the increased pressure in the positive air chamber 372 causes the shim 734 to bend away from the first side 728 of the piston 724. This allows additional from the positive air chamber 372 to flow along second flow paths 802a, 802b through the compression channels 732a, 732b and into the rebound damper chamber 704. As the front fork 200 begins to expand or rebound, the shim 734 re-engages and seals against the first side 728 of the piston 724, which closes the compression channels 732, 732b. During rebound, the air in the chamber 704 flows along the first flow path 800 and through the orifice 760 back into the positive air chamber 372. However, the orifice 760 is relatively small and results in a lower or slower release of the air back into the positive air chamber 372. This results in a reduced pressure in the positive air chamber 372 and therefore reduces the spring force during the high speed rebound. This reduces or eliminates the overly active feeling that would otherwise occur without the rebound damper 600.

In the illustrated example, a bushing 804 is disposed between the sleeve portion 754 of the restrictor adjuster 742 and the inner surface of the axial opening 744. The bushing 804 forms a fluid tight seal to prevent fluid leakage between the sleeve portion 754 and the inner surface of the axial opening 744 and also enables the restrictor adjuster 742 to rotate smoothly in the axial opening 744. In the illustrated example, a retainer 806 (e.g., a circlip, a ring, a washer) is used to secure the restrictor adjuster 742 in the axial opening 744. The retainer 806 is disposed in a groove on the inner surface of the axial opening 744 and engaged with the bottom end 750 of the restrictor adjuster 742, which blocks the restrictor adjuster 742 from moving downward out of the axial opening 744.

As disclosed above, the restrictor adjuster 742 can be rotated to align other ones of the orifices 760 with the radial opening 746 to increase or decrease the rebounding damping. In the illustrated example, the top end 748 of the restrictor adjuster 742 is accessible from the top side 706 of the second cap 700 to enable a user to access and rotate the restrictor adjuster 742. For example, a user can remove the cover 740 to access the restrictor adjuster 742, and then place the cover 740 back onto the second cap 358 afterwards. In this example, the top end 748 has a socket head (e.g., a hex-shaped bore) for receiving a tool such as a hexagonal wrench. A user can insert a tool into the top end 748 and rotate the restrictor adjuster 742. In other examples, a user can grasp and rotate the top end 748 with their hands.

FIG. 9 is perspective view of the restrictor adjuster 742. Three of the orifices 760 are shown in FIG. 9 and labeled as 760a, 760b, 760c. The orifices 760a, 760b, 760c are arranged circumferentially around the sleeve portion 754. The orifices 760a, 760b, 760c have different diameters. For example, the diameters increase from the first orifice 760a to the third orifice 760c. While in this example the restrictor adjuster 742 includes three orifices, in other examples, the restrictor adjuster 742 can include more or fewer orifices, such as two orifices, four orifices, five orifices, etc.

In some examples, the restrictor adjuster 742 can be rotated to and held in discrete rotational positions to align corresponding ones of the orifices 760a-760c with the radial opening 746. In some examples, the rebound damper 376 includes a ball and detent interface to define the discrete positions. For example, as shown in FIG. 9, the sleeve portion 754 has three detents 900a, 900b, 900c (e.g., recesses) formed in the outer surface near the bottom end 750. The detents 900a, 900b, 900c correspond to the rotational positions for certain ones of the orifices 760.

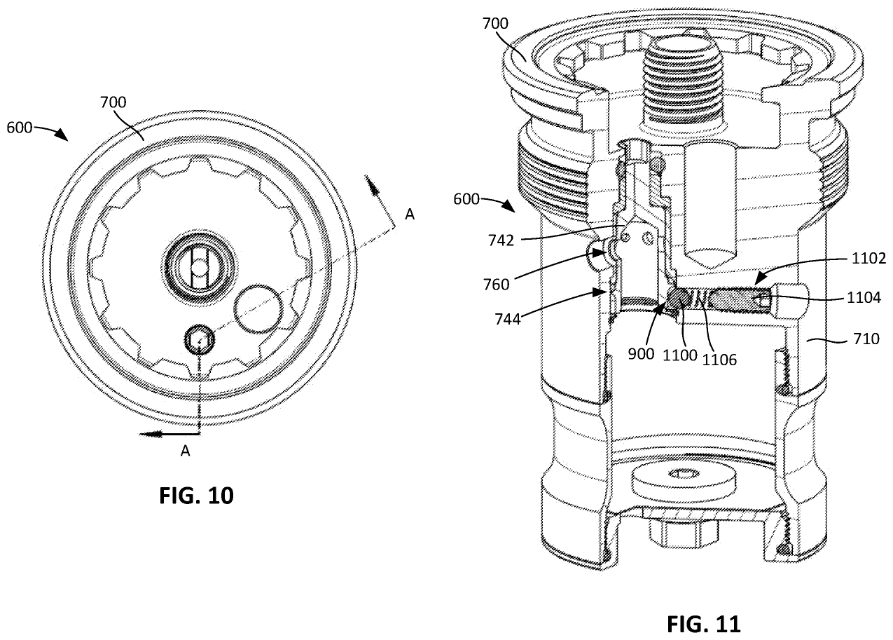

FIG. 10 is a top view of the rebound damper 600 and the second cap 700. FIG. 11 is a perspective cross-sectional view of the rebound damper 600 and the second cap 700 taken along line A-A of FIG. 10. As shown in FIG. 11, the rebound damper 600 includes a ball 1100 that is engaged with one of the detents 900 on the sleeve portion 754. The ball 1100 is disposed in a channel 1102 formed in the second cap 700. The channel 1102 extends between the axial opening 744 and the outer side surface 710 of the second cap 700. In the illustrated example, a screw 1104 is screwed into the channel 1102. Further, a spring 1106 is disposed in the channel 1102 between the screw 1104 and the ball 1100. The screw 1104 holds the spring 1106 against the ball 1100. The spring 1106 biases the ball 1100 toward the detents 900 on the restrictor adjuster 742. When the ball 1100 is engaged with one of the detents 900, the pressure from the ball 1100 holds the restrictor adjuster 742 in the current position. When a user applies a sufficient rotating force to the restrictor adjuster 742, the ball 1100 is pushed back into the channel 1102 and the restrictor adjuster 742 can be rotated to another position. When another detent 900 is aligned with the ball 1100, the ball 1100 is pushed into the detent 900 and holds the restrictor adjuster 742 in the new position. This ball and detent interface enables a user to turn the restrictor adjuster 742 to discrete positions that align the orifices 760 with the radial opening 746.

While in this example the restrictor adjuster 742 has discrete orifices that can be aligned with the radial opening 746, in other examples, the restrictor adjuster 742 may have one elongated slot that increase or decrease in width. A portion of the slot is aligned with the radial opening 746. The restrictor adjuster 742 can be rotated to align a larger or smaller portion of the slot with the radial opening 746 to affect the amount of air flow between the chambers. Therefore, in such an example, the restrictor adjuster 742 may not have discrete positions, but instead can be continuously rotatable to increase or decrease the damping rate.

The example rebound dampers 376, 600 utilize orifices to meter or restrict air flow from the rebound damper chamber back into the positive air chamber 372. The orifices act as passive valves that are always open. In other examples, the rebound dampers 376, 600 can include other types of valves to restrict or meter flow. For example, the rebound dampers 376, 600 could utilize check valves (e.g., shim valves) that open under a certain pressure differential and restrict fluid flow once opened.

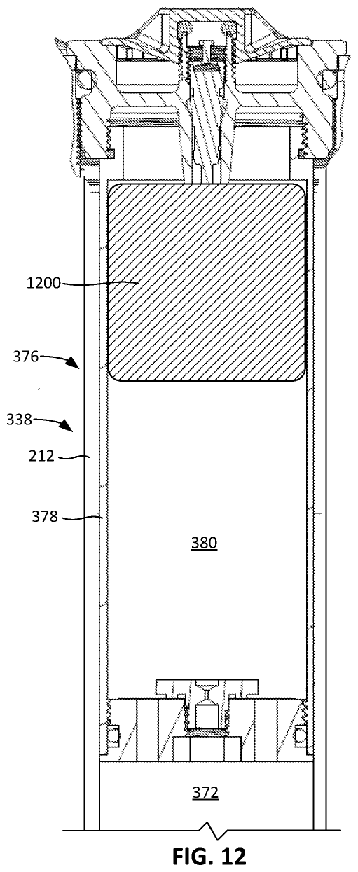

In some examples, the front fork 200 can include a volume spacer to consume or take up air volume in the air spring 338 to change or adjust the damping rate and overall spring rate for higher or lower damping forces and spring forces. For example, FIG. 12 is a cross-sectional view of the top portion of the second upper tube 212 and the air spring 338 similar to FIG. 4. In the example of FIG. 12, the air spring 338 includes an example volume spacer 1200 in the rebound damper chamber 380 of the rebound damper 376. In some examples, the volume spacer 1200 is a solid piece or hollow piece of material (e.g., plastic, polymer, metal) that consumes or takes up a portion of the volume in the rebound damper chamber 380. This reduces the amount of air in the rebound damper chamber 380, which reduces the damping effective provided by the rebound damper 376. As such, this changes the effective spring rate to be more progressive (e.g., exhibit higher forces). In this example, the volume spacer 1200 is cylindrical in shape. In some examples, the volume spacer 1200 has a diameter that is the same as or close to the inner diameter of the cylinder 378 and to form a friction fit with the cylinder 378. In some examples, the volume spacer 1200 has a diameter of 30 mm+/−20 mm, and a height of 30 mm+/−20 mm. However, in other examples, the volume spacer 1200 can be larger or smaller and may be shaped differently. In some examples, multiple volume spacers can be stacked and/or nested together for greater heights. Multiple volume spacers can be mechanically interlocked with one another with threads or interference features.

In other examples, the volume spacer 1200 can act as a volume increaser to change the effective spring rate to be less progressive and therefore more linear (e.g., exhibit lower forces). For example, the volume spacer 1200 is constructed of activated carbon. Activated carbon has a relatively large surface area that causes gas molecules to adsorb to the material's surface (through van der Waals forces), which essentially allows more gas molecules into a volume than would normally occupy that volume. As such, the activated carbon acts to increase the volume in the rebound damper chamber 380, which increases the effective rebound damping and, thus, changes the effective spring rate to be less progressive.

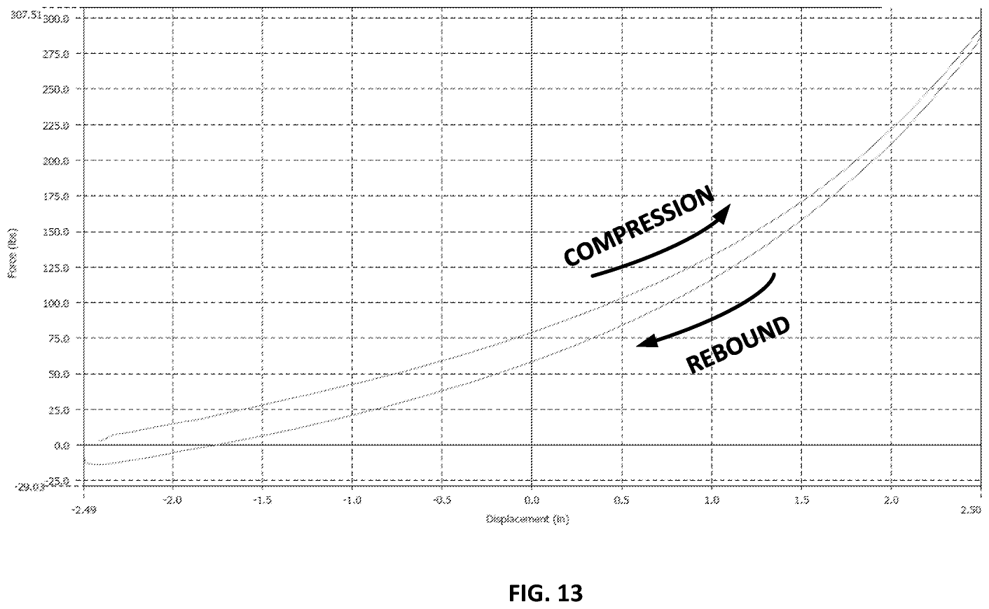

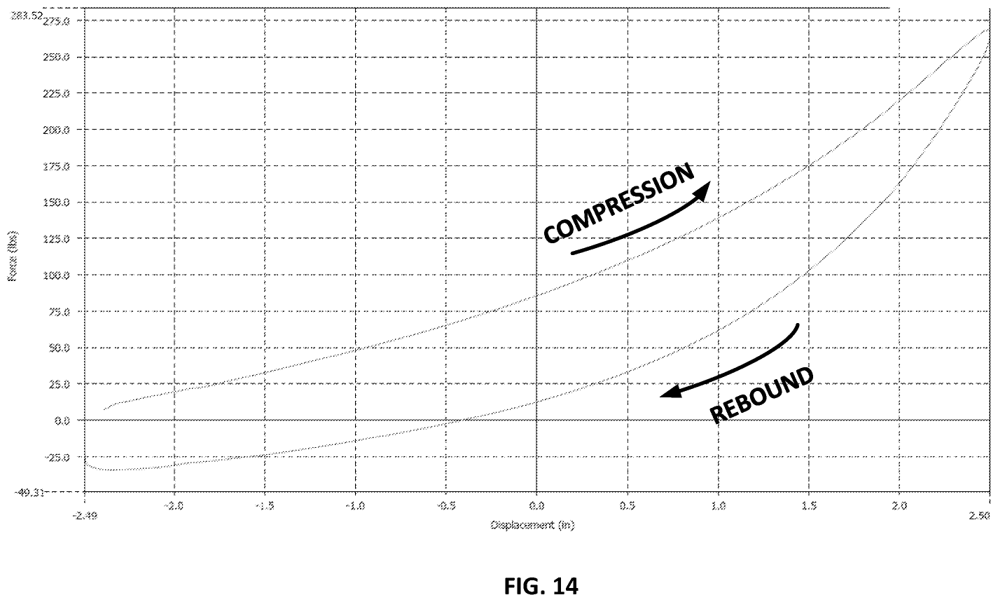

FIGS. 13 and 14 illustrate an example result of using a rebound damper, such as the rebound damper 376 or the rebound damper 600, on a positive air spring, such as the air spring 338. FIG. 13 is a graph of force versus displacement on a positive air spring without a rebound damper during a high speed compression and rebound cycle, such as at 80 inches per second. The amount of damping, also considered hysteresis, can be attributed to friction of the system. FIG. 14 is a graph of force versus displacement on a positive air spring with an example rebound damper during the same high speed compression and rebound event. The rebound curve is lower than in FIG. 13. As such, the rebound damper reduces the amount of force the air spring produces as the spring rebounds.

The example air springs with rebound dampers disclosed herein have been described in connection with right side up forks, which have the larger diameter tube on the bottom and the smaller diameter tube is on the top. However, it is understood that any of the examples disclosed herein can also be implemented on inverted fork designs, which have the larger diameter tube on the top and the smaller diameter tube on the bottom. Also, while the example front fork 200 of FIGS. 2 and 3 includes two legs, in other examples, the front fork 200 can be configured as a single-side fork that only includes one of the legs. In such an example, the single leg may include a damper, a spring, or a combination spring and damper. Also, while the air springs with rebound dampers are described in connection with a front fork, any of the example air springs with rebound dampers disclosed herein can also be implemented in another suspension component, such as the rear shock absorber 136.

As can be appreciated, the examples disclosed herein provide air damping to an air spring design that enables the suspension fork to reap the benefits of an air spring, but also assists in additional damping under certain conditions to complement the overall suspension system. The example air spring rebound dampers disclosed herein produce little (e.g., minimal) if any impact on the compression stroke force of an air spring while reducing the air spring force on the rebound stroke during higher speed rebound events. Any of the example rebound dampers disclosed herein can be added (e.g., retrofit) to existing air springs.

Example front forks for bicycles have been disclosed herein. The following paragraphs provide various examples and example combinations of the examples disclosed herein.

Example 1 is a front fork for a bicycle. The front fork comprises a leg including an upper tube and a lower tube configured in a telescopic arrangement and an air spring in the leg. The air spring includes a pneumatic chamber and a piston in the pneumatic chamber. The piston divides the pneumatic chamber into a positive air chamber and a negative air chamber. The front fork also includes a rebound damper including a rebound damper chamber. The rebound damper chamber is in fluid communication with the positive air chamber via a first flow path and a second flow path. The first flow path is defined by an orifice. During a compression event, the first flow path and the second flow path are configured to allow air to flow from the positive air chamber to the rebound damper chamber. During a rebound event, the second flow path is configured to be closed such that air in the rebound damper chamber flows along the first flow path through the orifice into the positive air chamber at a metered rate.

Example 2 includes the front fork of Example 1, wherein the rebound damper includes: a cylinder defining the rebound damper chamber; and a piston coupled to the cylinder. The piston has a first side facing the rebound damper chamber and a second side, opposite the first side, facing the positive air chamber.

Example 3 includes the front fork of Example 2, wherein the piston has a compression channel extending through the piston, the compression channel defining the second flow path.

Example 4 includes the front fork of Example 3, wherein the rebound damper includes a shim on the first side of the piston and covering the compression channel, wherein during the compression event, higher pressure in the positive air chamber causes the shim to bend away from the first side of the piston to allow air flow through the compression channel.

Example 5 includes the front fork of Example 4, wherein the rebound damper includes a shim nut coupled to the piston to hold the shim against the first side of the piston.

Example 6 includes the front fork of claim 5, wherein the shim nut defines the orifice.

Example 7 includes the front fork of Example 1, further including a cap coupled to a top end of the upper tube, the rebound damper including a cylinder defining the rebound damper chamber, the cylinder coupled to and extending from the cap.

Example 8 includes the front fork of Example 7, further including a restrictor adjuster having a set of orifices, the orifices having different diameters.

Example 9 includes the front fork of Example 8, wherein the cap has an axial opening extending between a top side and a bottom side of the cap, and wherein the cap has a radial opening extending between the axial opening and an outer side surface of the cap.

Example 10 includes the front fork of Example 9, wherein the restrictor adjuster is disposed in the axial opening of the cap, the restrictor adjuster having a sleeve portion with a hollow interior defined by a bore extending into a bottom end of the restrictor adjuster, the sleeve portion having the set of orifices, and wherein the restrictor adjuster is rotatable in the axial opening to align different ones of the orifices with the radial opening.

Example 11 includes the front fork of Example 10, wherein the restrictor adjuster has a top end that is accessible from the top side of the cap to enable a user to access and rotate the restrictor adjuster.

Example 12 includes the front fork of Example 11, wherein the top end of the restrictor adjuster has a socket head.

Example 13 includes the front fork of any of Examples 8-12, further including a ball and detent interface to hold the restrictor adjuster in discrete positions.

Example 14 includes the front fork of any of Examples 1-13, wherein the pneumatic chamber is formed by an interior of the upper tube, the piston slidable within the upper tube.

Example 15 includes the front fork of any of Examples 1-14, wherein the leg is a first leg, the upper tube is a first upper tube, and the lower tube is a first lower tube, the front fork including: a second leg including a second upper tube and a second lower tube configured in a telescopic arrangement; and a damper in the second leg.

Example 16 is a front fork for a bicycle. The front fork comprises a leg including an upper tube and a lower tube configured in a telescopic arrangement, a piston in an interior of the upper tube, the piston dividing the interior of the upper tube into a positive air chamber and a negative air chamber, a cylinder in the upper tube, the cylinder defining a rebound damper chamber, and a flow control member having an orifice. The orifice defines a portion of a flow path between the rebound damper chamber and the positive air chamber. The orifice is to restrict air flow from the rebound damper chamber to the positive air chamber during a high speed rebound event.

Example 17 includes the front fork of Example 16, further including a cap coupled to a top end of the upper tube, wherein the cylinder is coupled to the cap.

Example 18 includes the front fork of Example 17, wherein the cylinder is spaced from an inner surface of the upper tube such that a gap is formed between the cylinder and the upper tube.

Example 19 includes the front fork of any of Examples 16-18, further including a volume spacer in the rebound damper chamber.

Example 20 includes the front fork of Example 19, wherein the volume spacer is constructed of activated carbon.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. A front fork for a bicycle, the front fork comprising:
a leg including an upper tube and a lower tube configured in a telescopic arrangement;
an air spring in the leg, the air spring including a pneumatic chamber and a piston in the pneumatic chamber, the piston dividing the pneumatic chamber into a positive air chamber and a negative air chamber; and
a rebound damper including a rebound damper chamber, the rebound damper chamber in fluid communication with the positive air chamber via a first flow path and a second flow path, the first flow path defined by an orifice,
wherein, during a compression event, the first flow path and the second flow path are configured to allow air to flow from the positive air chamber to the rebound damper chamber, and
wherein, during a rebound event, the second flow path is configured to be closed such that air in the rebound damper chamber flows along the first flow path through the orifice into the positive air chamber at a metered rate.

2. The front fork of claim 1, wherein the rebound damper includes:
a cylinder defining the rebound damper chamber; and
a piston coupled to the cylinder, the piston having a first side facing the rebound damper chamber and a second side, opposite the first side, facing the positive air chamber.

3. The front fork of claim 2, wherein the piston has a compression channel extending through the piston, the compression channel defining the second flow path.

4. The front fork of claim 3, wherein the rebound damper includes a shim on the first side of the piston and covering the compression channel, wherein during the compression event, higher pressure in the positive air chamber causes the shim to bend away from the first side of the piston to allow air flow through the compression channel.

5. The front fork of claim 4, wherein the rebound damper includes a shim nut coupled to the piston to hold the shim against the first side of the piston.

6. The front fork of claim 5, wherein the shim nut defines the orifice.

7. The front fork of claim 1, further including a cap coupled to a top end of the upper tube, the rebound damper including a cylinder defining the rebound damper chamber, the cylinder coupled to and extending from the cap.

8. The front fork of claim 7, further including a restrictor adjuster having a set of orifices, the orifices having different diameters.

9. The front fork of claim 8, wherein the cap has an axial opening extending between a top side and a bottom side of the cap, and wherein the cap has a radial opening extending between the axial opening and an outer side surface of the cap.

10. The front fork of claim 9, wherein the restrictor adjuster is disposed in the axial opening of the cap, the restrictor adjuster having a sleeve portion with a hollow interior defined by a bore extending into a bottom end of the restrictor adjuster, the sleeve portion having the set of orifices, and wherein the restrictor adjuster is rotatable in the axial opening to align different ones of the orifices with the radial opening.

11. The front fork of claim 10, wherein the restrictor adjuster has a top end that is accessible from the top side of the cap to enable a user to access and rotate the restrictor adjuster.

12. The front fork of claim 11, wherein the top end of the restrictor adjuster has a socket head.

13. The front fork of claim 8, further including a ball and detent interface to hold the restrictor adjuster in discrete positions.

14. The front fork of claim 1, wherein the pneumatic chamber is formed by an interior of the upper tube, the piston slidable within the upper tube.

15. The front fork of claim 1, wherein the leg is a first leg, the upper tube is a first upper tube, and the lower tube is a first lower tube, the front fork including:
a second leg including a second upper tube and a second lower tube configured in a telescopic arrangement; and
a damper in the second leg.

16. A front fork for a bicycle, the front fork comprising:
a leg including an upper tube and a lower tube configured in a telescopic arrangement;
a piston in an interior of the upper tube, the piston dividing the interior of the upper tube into a positive air chamber and a negative air chamber;
a cylinder in the upper tube, the cylinder defining a rebound damper chamber; and
a flow control member having an orifice, the orifice defining a portion of a flow path between the rebound damper chamber and the positive air chamber, the orifice to restrict air flow from the rebound damper chamber to the positive air chamber during a high speed rebound event.

17. The front fork of claim 16, further including a cap coupled to a top end of the upper tube, wherein the cylinder is coupled to the cap.

18. The front fork of claim 17, wherein the cylinder is spaced from an inner surface of the upper tube such that a gap is formed between the cylinder and the upper tube.

19. The front fork of claim 16, further including a volume spacer in the rebound damper chamber.

20. The front fork of claim 19, wherein the volume spacer is constructed of activated carbon.
